(19) United States
(12) Patent Application Publication
(10) Pub. No.: US 2009/0216836 A1
(43) Pub. Date: Aug. 27, 2009

(54) Saving a Draft Message in an Instant Messaging Environment

(76) Inventors: Thomas Richard Haynes, Apex, NC (US); Lin Sun, Morrisville, NC (US)

Correspondence Address: IBM CORPORATION - RSW (JVL);C/O VAN LEEUWEN & VAN LEEUWEN, P.O. BOX 90609, AUSTIN, TX, 78709-0609, US

(21) Appl. No.: 12/036,577

(22) Filed: Feb. 25, 2008

(51) Int. Cl. G06F 15/16

(52) U.S. Cl. 709/204

(57) ABSTRACT

A system, method, and program product is provided that establishes an first instant messaging session between two users. During the first instant messaging session, the first user composes an instant message. Before the first user can send the composed instant message to the second user, a detection is made that the second user has logged off of the instant messaging session. A draft of the instant message is saved at the first user's computer system onto a nonvolatile storage device. At a later time, a second instant messaging session is established between the two users. In response to the second instant messaging being established, the draft of the instant message saved on the first computer system is identified and retrieved from the nonvolatile storage device. The retrieved draft of the instant messaging is then sent from the first computer system to the second computer system.

### BACKGROUND OF THE INVENTION

1. Technical Field

The present invention relates to a system, method, and program product that saves a draft message in an instant messaging environment.

2. Description of the Related Art

Communication and collaboration have quickly become key elements of enterprise software. One feature that exists in enterprise software packages is the ability for a user to conduct a “chat” session with other online users (e.g., instant messaging).

Enterprise software typically invokes an instant messaging session in a generic context. Meaning, a user selects a recipient, and the enterprise software invokes a chat session between the user and the recipient without regard for the user's purpose for communicating with the recipient. In addition, the importance of a message is not always known. A challenge in traditional instant messaging sessions is that once one of the parties logs off the instant messaging session, instant messages that were being drafted to the logged-off party are not easily saved, especially in the instant messaging environment. When the parties resume another instant messaging session at a later date, it is often difficult to remember additional instant messages that were drafted but were unable to be sent because one of the parties had to end the instant messaging session.

### SUMMARY

It has been discovered that the aforementioned challenges are resolved by establishing, over a computer network (e.g., the Internet, a Local Area Network (LAN), etc.), a first instant messaging session between a first computer system used by a first user and a second computer system used by a second user. During the first instant messaging session, the first user composes an instant message. Before the first user can send the composed instant message to the second user, a detection is made (e.g., from a signal or message received from the second user) that the second user has logged off of the instant messaging session. In response to detecting that the second user has logged off, a draft of the instant message is saved at the first user's computer system onto a nonvolatile storage device.

At a later time, a second instant messaging session is established between the first and second users. In response to the second instant messaging being established, the draft of the instant message saved on the first computer system is identified and retrieved from the nonvolatile storage device. The retrieved draft of the instant messaging is then sent from the first computer system to the second computer system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a flowchart showing high-level steps taken by two parties of in instant messaging session;

FIG. 4 is a flowchart showing steps taken to identify and handle previous unsent messages an instant messaging session is initiated;

FIG. 5 is a flowchart showing steps taken to process user actions when handling identified unsent messages; and

FIG. 6 is a flowchart showing steps taken the parties to send and receive instant messages, including logic to save a draft of an instant messaging when the recipient has ended the instant messaging session.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

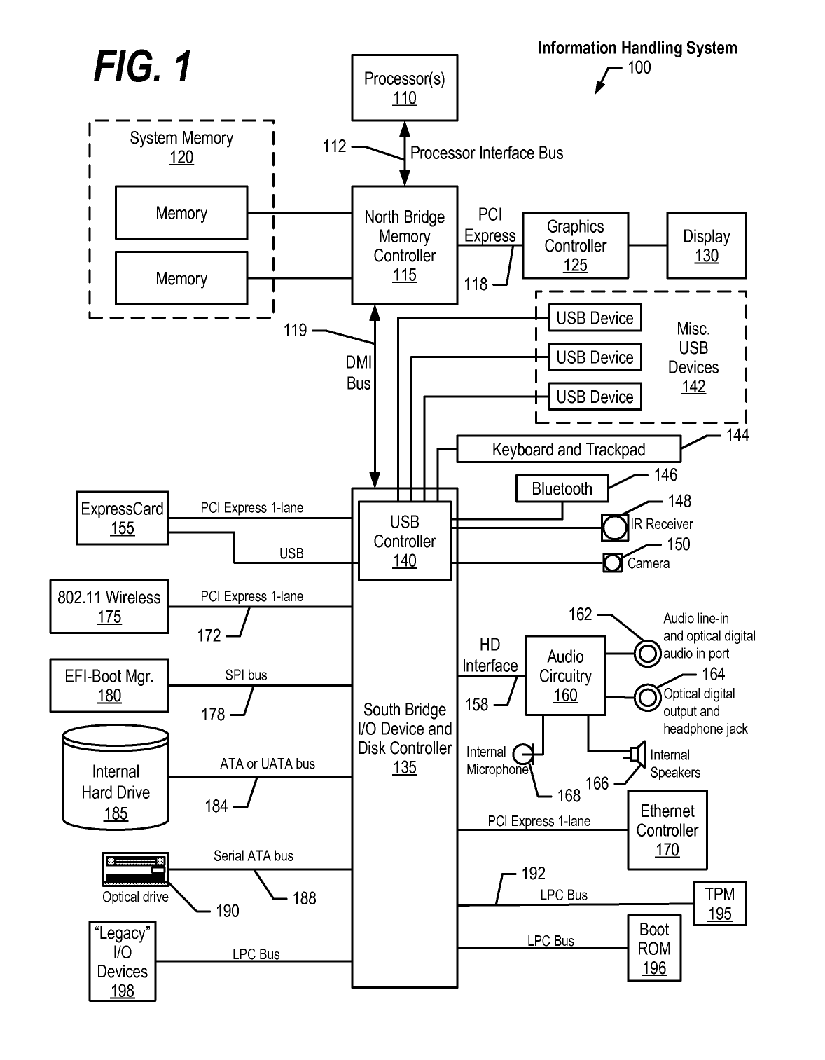

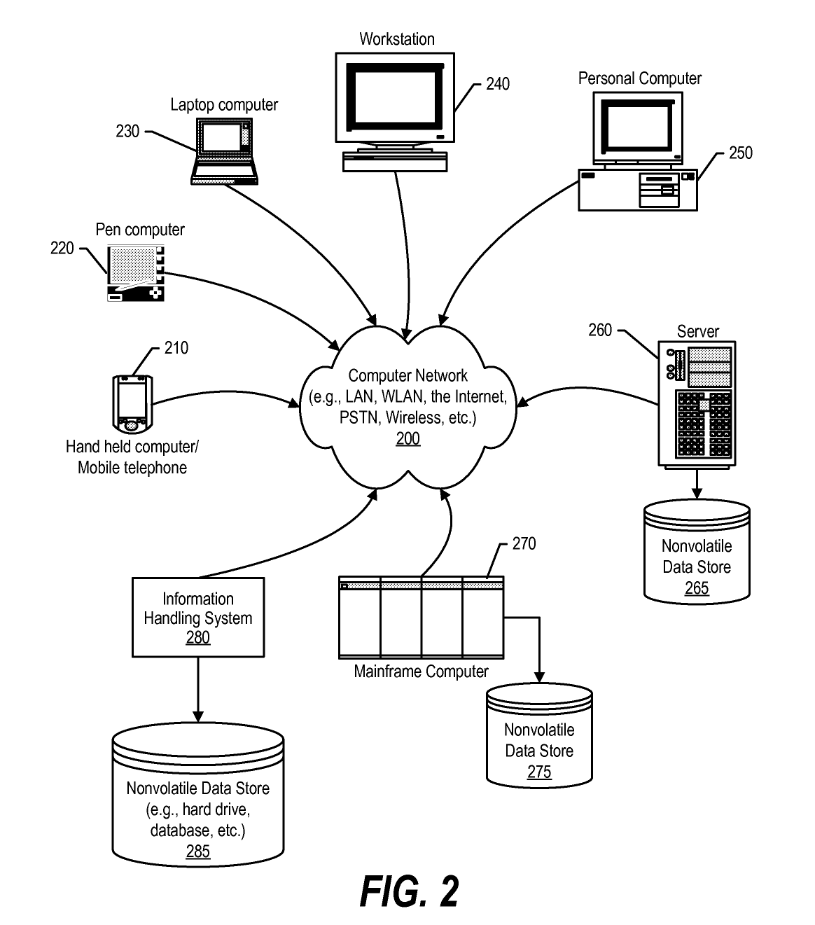

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100 which is a simplified example of a computer system capable of performing the computing operations described herein. Information handling system 100 includes one or more processors 110 which are coupled to processor interface bus 112. Processor interface bus 112 connects processors 110 to Northbridge 115, which is also known as the Memory Controller Hub (MCH). Northbridge 115 is connected to system memory 120 and provides a means for processor(s) 110 to access the system memory. Graphics controller 125 is also connected to Northbridge 115. In one embodiment, PCI Express bus 118 is used to connect Northbridge 115 to graphics controller 125. Graphics controller 125 is connected to display device 130, such as a computer monitor.

Northbridge 115 and Southbridge 135 are connected to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus is used to connect the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses can include PCI and PCI Express busses, an ISA bus, a System Management Bus (SMBus or SMB), a Low Pin Count (LPC) bus. The LPC bus is often used to connect low-bandwidth devices, such as boot ROM 196 and “legacy” I/O devices (using a “super I/O” chip). The “legacy” I/O devices (198) can include serial and parallel ports, keyboard, mouse, floppy disk controller. The LPC bus is also used to connect Southbridge 135 to Trusted Platform Module (TPM) 195. Other components often included in Southbridge 135 include a Direct Memory Access (DMA) controller, a Programmable Interrupt Controller (PIC), a storage device controller, which connects Southbridge 135 to nonvolatile storage device 300 such as a hybrid hard disk drive, using bus 184.

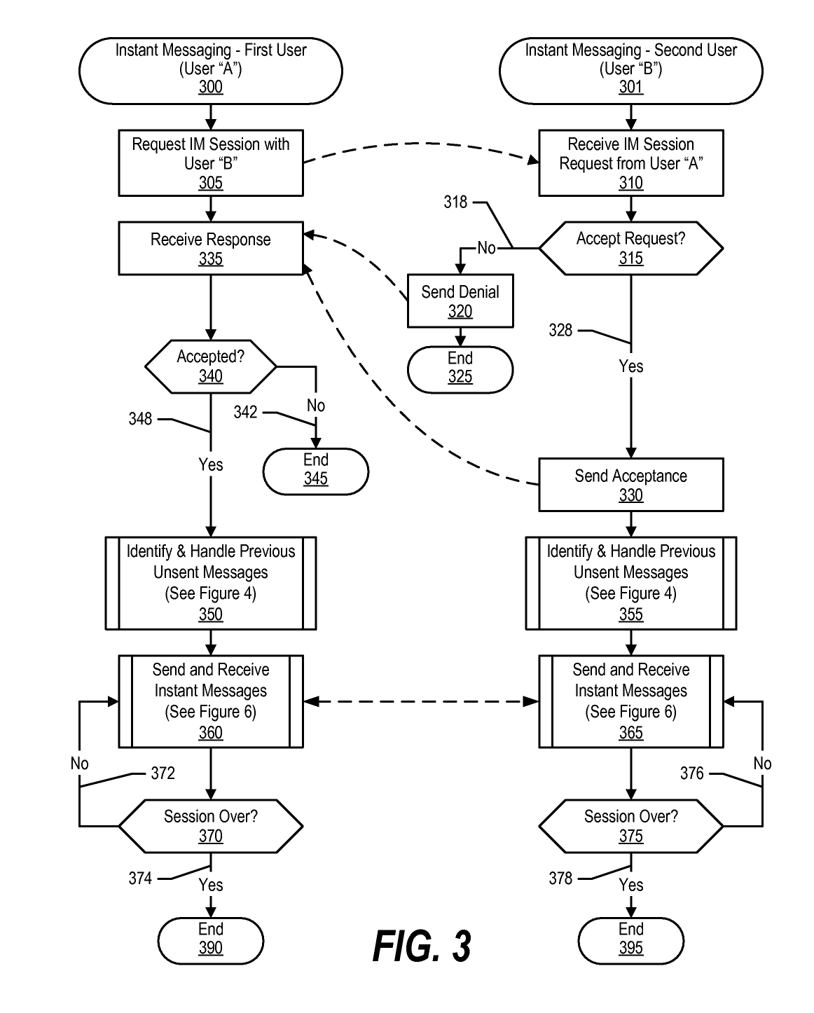

ExpressCard 155 is a slot used to connect hot-pluggable devices to the information handling system. ExpressCard 155 supports both PCI Express and USB connectivity as it is connected to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, Bluetooth device 146 which provides for wireless personal area networks (PANs), keyboard and trackpad 144, and other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etc. Removable storage device 145 can also be a hybrid disk drive, such as hybrid disk drive 300 shown in FIGS. 3-6.

Wireless Local Area Network (LAN) device 175 is connected to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 is connected to Southbridge 135 using Serial ATA (SATA) bus 188. Serial ATA adapters and devices communicate over a high-speed serial link. The Serial ATA bus is also used to connect Southbridge 135 to other forms of storage devices, such as hard disk drives. Audio circuitry 160, such as a sound card, is connected to Southbridge 135 via bus 158. Audio circuitry 160 is used to provide functionality such as audio line-in and optical digital audio in port 162, optical digital output and headphone jack 164, internal speakers 166, and internal microphone 168. Ethernet controller 170 is connected to Southbridge 135 using a bus, such as the PCI or PCI Express bus. Ethernet controller 170 is used to connect information handling system 100 with a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems which operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling system include nonvolatile data stores, such as hard drives and/or nonvolatile memory. Some of the information handling systems shown in FIG. 2 are depicted with separate nonvolatile data stores (server 260 is shown with nonvolatile data store 265, mainframe computer 270 is shown with nonvolatile data store 275, and information handling system 280 is shown with nonvolatile data store 285). The nonvolatile data store can be a component that is external to the various information handling systems or can be internal to one of the information handling systems. In addition, removable nonvolatile storage device 145 can be shared amongst two or more information handling systems using various techniques, such as connecting the removable nonvolatile storage device 145 to a USB port or other connector of the information handling systems.

FIG. 3 is a flowchart showing high-level steps taken by two parties of in instant messaging session. Processing that is performed by a first computer system that is being used by a first user is shown commencing at 300 and processing that is performed by a second computer system that is being used by a second user is shown commencing at 301. At step 305 the first user requests an instant messaging session with the second user by sending an instant messaging session request through a computer network, such as the Internet, a local area network (LAN), etc., to the second user's computer system where the request is received at step 310. A determination is made as to whether to accept the request to establish the instant messaging session (decision 315). If the second computer system decides not to establish the instant messaging session, then decision 315 branches to “no” branch 318 whereupon, at step 320, a denial response is sent and second computer system processing ends at 325. On the other hand, if the second computer system decides to accept the request to establish an instant messaging session, then decision 315 branches to “yes” branch 328 whereupon, at step 330, an acceptance response is sent. Returning to first computer system processing, at step 335, the response of the second computer system is received. A determination is made as to whether the second computer system accepted the request to establish an instant messaging session (decision 340). If the second computer system denied the request, then decision 340 branches to “no” branch 342 whereupon first computer system processing ends at 345. On the other hand, if the second computer system accepted the request, then decision 340 branches to “yes” branch 348 for further processing. While the first computer system is shown requesting the instant messaging session in FIG. 3, the same processing could be performed with the second computer system requesting the instant messaging session. In other words, either user can request to establish the instant messaging session with the other user.

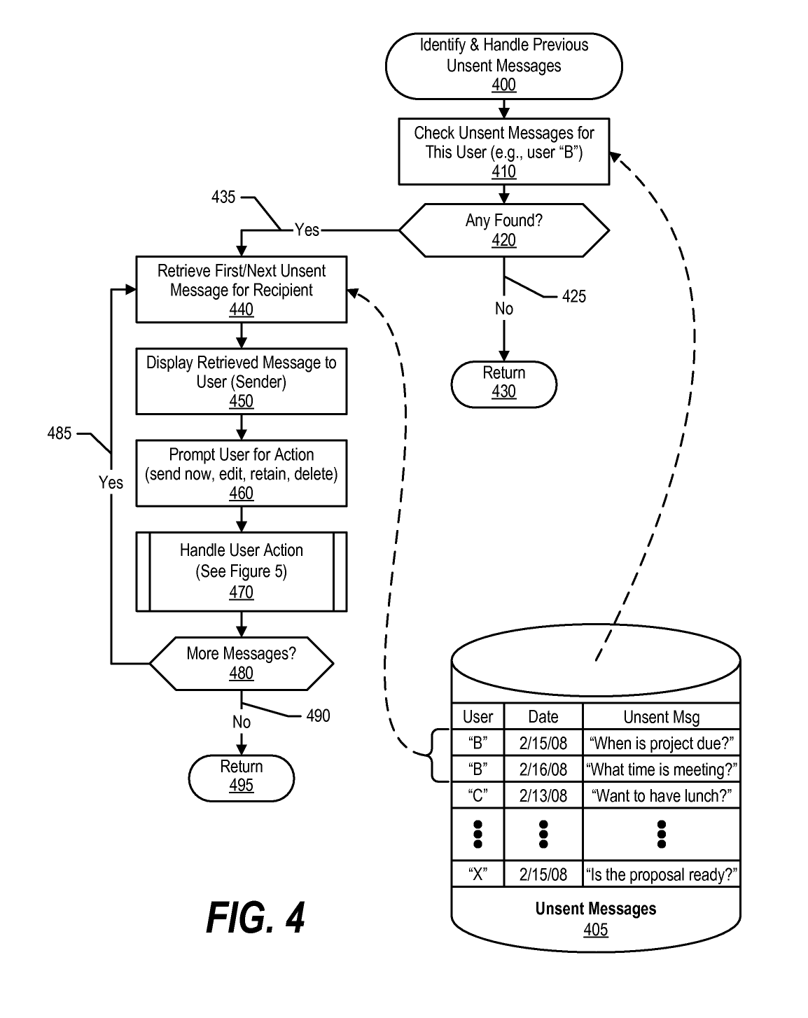

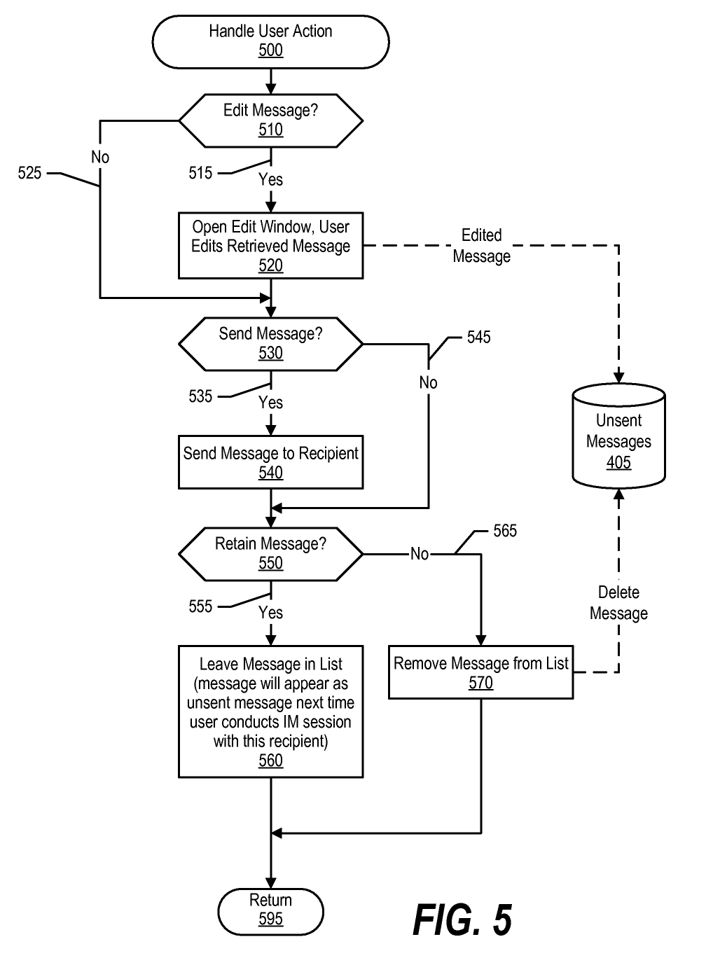

Predefined processes are preformed at each computer system to identify and handle any previously unsent messages (predefined process 350 and predefined process 355 for the first and second computer systems, respectively, see FIG. 4 and corresponding text for processing details). Predefined processes are also performed at each computer system to send and receive instant messages (predefined process 360 and predefined process 365 for the first and second computer systems, respectively, see FIG. 5 and corresponding text for processing details). A determination is made as to whether the user has ended the instant messaging session (decision 370 corresponding to the first user that is using the first computer system and decision 375 corresponding to the second user that is using the second computer system). If the user has not ended the session, then processing loops back to predefined processes 360 and 365 in order to continue sending and receiving instant messages (“no” branches 372 and 376, respectively). During predefined process 360 and 365, logic is included to save an instant message that has been composed by one of the users but cannot be sent because the other user logs off of the instant messaging session before the message is sent. This looping continues until one of the participants of the instant messaging session (either the first or the second user) logs off of the instant messaging session, at which point decisions 370 and 375 branch to “yes” branch 374 and 378, respectively, whereupon processing ends at 390 and 395, respectively.

FIG. 4 is a flowchart showing steps taken to identify and handle previous unsent messages an instant messaging session is initiated. Processing commences at 400 whereupon, at step 410, the process checks for any unsent messages that were composed during a previous instant messaging session with the other user and stored in unsent messages data store 405. For example, when this process is performed by the first user (user “A”), then unsent messages data store 405 is checked for messages that were composed to be sent to the second user (user “B”). Likewise, when this process is performed by the second user (user “B”), then unsent messages data store 405 is checked for messages that were composed to be sent to the first user (user “A”). In the example shown, the first user (user “A”) is executing the process and two entries exist in unsent messages data store 405 that were being composed to be sent to the second user (user “B”). As can be seen, other unsent messages are stored in data store 405 that were being composed to be sent to other users, such as users “C” and “X.” When the user establishes an instant messaging session with one of these other users (e.g., user “C”), then data store 405 is checked for the existence of previously saved messages that were composed and intended to be sent to these other users.

A determination is made as to whether any unsent messages are found in data store 405 that were composed and intended to be sent to the user with whom this user has established an instant messaging session (decision 420). If no messages are found corresponding to the other user, then decision 420 branches to “no” branch 425 and processing returns to the calling routine (see FIG. 4) at 430. On the other hand, if one or more previously composed messages are found in data store 405 that are directed to the other user, then decision 420 branches to “yes” branch 435 whereupon, at step 440, the first unsent message that is directed to the other user (the recipient) is retrieved. At step 450, the retrieved message is displayed to the user whose computer system is executing the process shown in FIG. 4 (e.g., the first user or user “A”). At step 460, the user is prompted for an action to take with respect to the retrieved message (e.g., send the message, edit the message, retain the message in data store 405, and delete the message from data store 405). At predefined process 470 the action selected by the user is processed (see FIG. 5 and corresponding text for processing details). A determination is made as to whether there are additional unsent messages that were composed with the intent to sending to the other user (decision 480). If there are additional messages, then decision 480 branches to “yes” branch 485 which loops back to retrieve the next unsent message directed to the other user and process it according to the user's preferences. This looping continues until all of the unsent messages that correspond to the other user have been processed, at which point decision 480 branches to “no” branch 490 and processing returns to the calling routine (see FIG. 3) at 495.

FIG. 5 is a flowchart showing steps taken to process user actions when handling identified unsent messages. Processing commences at 500. The action requested by the user for the selected message was previously retrieved in step 460 shown in FIG. 4. In FIG. 5, a determination is made as to whether the user requested to edit the selected message (decision 510). If the user selected to edit the selected message, then decision 510 branches to “yes” branch 515 whereupon, at step 520, an edit window is opened allowing the user to edit the retrieved message and the edited message is retained (e.g., in unsent messages data store 405). On the other hand, if the user does not wish to edit the retrieved unsent message, then decision 510 branches to “no” branch 525 bypassing step 520.

A determination is made as to whether the user wishes to send the message (decision 530). The message can be sent either with or without editing the message as provided by step 520. If the user wishes to send the message, then decision 530 branches to “yes” branch 535 whereupon, at step 540, the message is sent to the other user (e.g. to the second user). On the other hand, if the user does not wish to send the retrieved message, then decision 530 branches to “no” branch 545 bypassing step 540.

A determination is made as to whether the user wishes to retain the message in unsent messages data store 405 (decision 550). If the user wants to retain the message, then decision 550 branches to “yes” branch 555 whereupon, as noted in block 560, the message is left in the unsent messages data store 405 and it will appear as an unsent message the next time the user establishes an instant messaging session with the other user. On the other hand, if the user does not wish to retain the message (e.g., the message is no longer applicable, or the user sent the message to the other user in step 540), then decision 550 branches to “no” branch 565 whereupon, at step 570, the retrieved message is deleted from unsent messages data store 405. Processing thereafter returns to the calling routine (see FIG. 4) at 595.

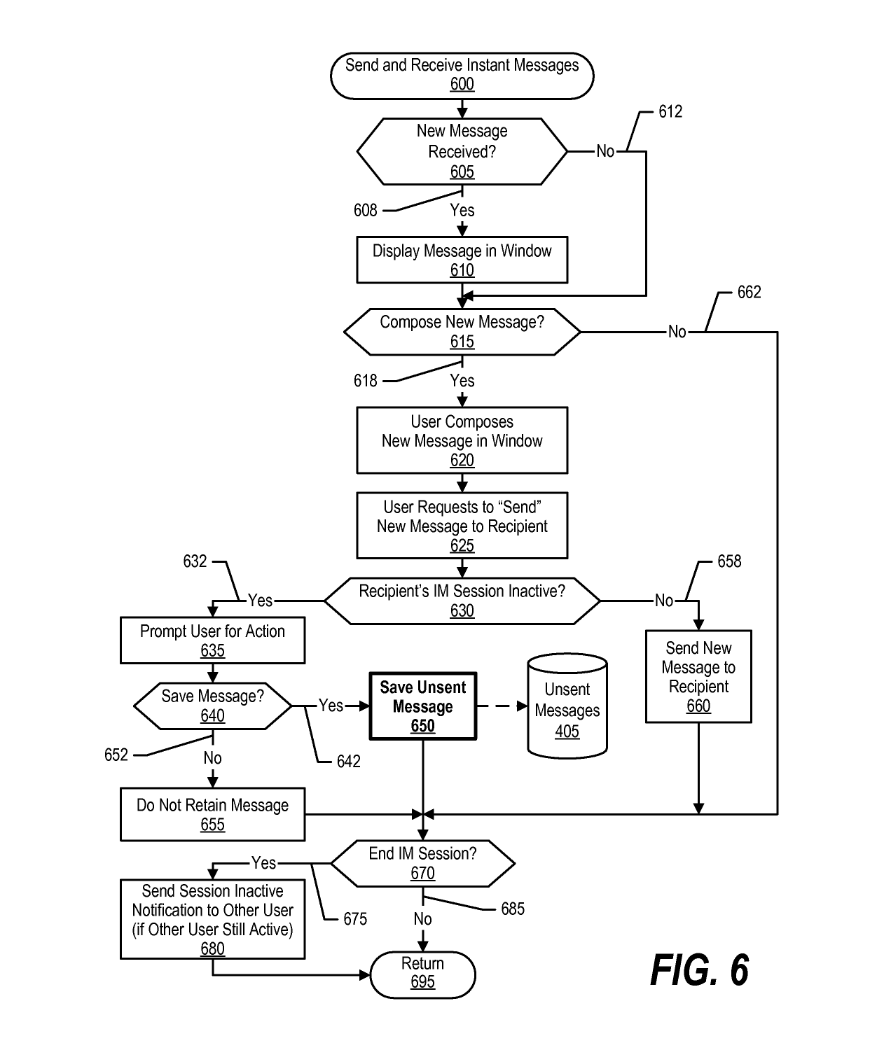

FIG. 6 is a flowchart showing steps taken the parties to send and receive instant messages, including logic to save a draft of an instant messaging when the recipient has ended the instant messaging session. Processing commences at 600 whereupon a determination is made as to whether a new message was received from the other user of the instant messaging session (decision 605). For example, the first user (user “A”) may have received a new message from the second user (user “B”). If a new message has been received, then decision 605 branches to “yes” branch 608 whereupon, at step 610, the received message is displayed in a window (e.g., on the first user's computer system). If a new message was not received, then decision 605 branches to “no” branch 612 bypassing step 610.

A determination (decision 615) is made as to whether the user wishes to compose a new message directed to the other user (e.g., the first user (user “A”) wishes to compose a new message to the second user (user “B”)). If the user wishes to compose a new message, then decision 615 branches to “yes” branch 618 whereupon, at step 620, the user composes a new instant message in a window. At step 625, the user requests to send the newly composed message to the other user. A determination is made as to whether the other user has logged off of the instant messaging session (decision 630). In other words, a determination is made as to whether the intended recipient of the newly composed instant message now has an inactive instant messaging session. If the recipient's instant messaging session is inactive, then decision 630 branches to “yes”branch 632 whereupon, at step 635, the user (the sender) is prompted for an action. A determination is made as to whether the user that composed the instant message wishes to save the unsent instant message (decision 640). If the user wishes to save the unsent instant message, then decision 640 branches to “yes” branch 642 whereupon, at step 650, the unsent message is saved in unsent messages data store 405. On the other hand, if the user does not wish to save the unsent instant message, then decision 640 branches to “no” branch 652 whereupon, as noted in block 655, the unsent instant message is not retained.

Returning to decision 630, if the other user (the recipient) is still logged into the instant messaging session, then decision 630 branches to “no” branch 658 whereupon, at step 660, the newly composed instant message is sent to the other user.

Returning to decision 615, if the user is not composing a new instant message, then decision 615 branches to “no” branch 662 bypassing the composition steps shown in steps 620 to 660.

After instant messages have been received and/or sent, a determination is made as to whether the user wishes to end the established instant messaging session (decision 670). If the user wishes to end the instant messaging session, then decision 670 branches to “yes” branch 675 whereupon, at step 680, a notification is sent to the other user that informs the other user that this user is no longer logged into the instant messaging session. On the other hand, if the user is not ending the instant messaging session, then decision 670 branches to “no” branch 685 whereupon processing returns to the calling routine (see FIG. 3) at 695.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
establishing, over a computer network, a first instant messaging session between a first computer system used by a first user and a second computer system used by a second user;
composing, by the first user, an instant message;
detecting that the second user has logged off the instant messaging session before the first user can send the composed instant message;
saving, at the first computer system, a draft of the instant message on a nonvolatile storage device accessible from the first computer system;
establishing, over the computer network, a second instant messaging session between the first computer system used by the first user and the second computer system used by the second user;
identifying the saved draft of the instant message in response to establishing the second instant messaging;
retrieving the saved draft of the instant message from the nonvolatile storage device accessible from the first computer system; and
sending the identified saved draft of the instant messaging from the first computer system to the second computer system.

2. The method of claim 1 further comprising:
after the identifying, loading the saved draft of the instant message into an editor; and
receiving one or more edits to the loaded draft, wherein the saved draft of the instant message that is sent to the second computer system includes the one or more edits.

3. The method of claim 1 further comprising:
after the identifying, displaying the saved draft of the instant message to the first user; and
receiving a request from the first user, wherein the identified saved draft of the instant message is sent in response to the first user requesting to send the saved draft of the instant message.

4. The method of claim 3 further comprising:
retaining the saved draft of the instant message in response to the first user requesting the retain the saved draft of the instant message.

5. The method of claim 1 wherein the saving further comprises:
storing an identifier that corresponds to the second user and the draft of the instant message in a data store, wherein the data store includes a plurality of identifiers, including the second user's identifier, wherein each of the identifiers corresponds to an unsent message, including the draft of the instant message.

6. The method of claim 5 wherein the identifying further comprises:
checking the data store for the second user's identifier when the second instant messaging session is established.

7. The method of claim 6 further comprising:
identifying a plurality of unsent messages, including the draft of the instant message, in the data store, wherein each of the plurality of unsent messages corresponds to the second user's identifier;
receiving one or more selections from the first user, wherein each of the one or more selections corresponds to one of the plurality of unsent messages, wherein one of the selections corresponds to the draft of the instant message; and
sending to the second computer system being used by the second user, each of the unsent messages, including the draft of the instant message, that corresponds to one of the selections.

8. A information handling system, which is a first computer system and is being used by a first user, the information handling system comprising:
one or more processors;
a memory accessible by at least one of the processors;
a nonvolatile storage device accessible by at least one of the processors;
a network adapter, accessible by at least one of the processors, that connects the information handling system to a computer network; and
a set of instructions which are loaded into memory and executed by at least one of the processors while the computer system is booted from the alternate boot media in order to perform actions of:
establishing, over the computer network, a first instant messaging session between the first computer system used by the first user and a second computer system used by a second user;
composing, by the first user, an instant message;
detecting that the second user has logged off the instant messaging session before the first user can send the composed instant message;
saving, at the first computer system, a draft of the instant message on the nonvolatile storage device;
establishing, over the computer network, a second instant messaging session between the first computer system used by the first user and the second computer system used by the second user;
identifying the saved draft of the instant message in response to establishing the second instant messaging;
retrieving the saved draft of the instant message from the nonvolatile storage device accessible; and
sending the identified saved draft of the instant messaging from the first computer system to the second computer system.

9. The information handling system of claim 8 wherein the instructions executed by at least one of the processors perform additional actions comprising:
after the identifying, loading the saved draft of the instant message into an editor; and
receiving one or more edits to the loaded draft, wherein the saved draft of the instant message that is sent to the second computer system includes the one or more edits.

10. The information handling system of claim 8 wherein the instructions executed by at least one of the processors perform additional actions comprising:
after the identifying, displaying the saved draft of the instant message to the first user; and
receiving a request from the first user, wherein the identified saved draft of the instant message is sent in response to the first user requesting to send the saved draft of the instant message.

11. The information handling system of claim 10 wherein the instructions executed by at least one of the processors perform additional actions comprising:
retaining the saved draft of the instant message in response to the first user requesting the retain the saved draft of the instant message.

12. The information handling system of claim 8 wherein the instructions executed by at least one of the processors to perform the saving perform additional actions comprising:
storing an identifier that corresponds to the second user and the draft of the instant message in a data store, wherein the data store includes a plurality of identifiers, including the second user's identifier, wherein each of the identifiers corresponds to an unsent message, including the draft of the instant message.

13. The information handling system of claim 12 wherein the instructions executed by at least one of the processors to perform the identifying perform additional actions comprising:
checking the data store for the second user's identifier when the second instant messaging session is established;
identifying a plurality of unsent messages, including the draft of the instant message, in the data store, wherein each of the plurality of unsent messages corresponds to the second user's identifier;
receiving one or more selections from the first user, wherein each of the one or more selections corresponds to one of the plurality of unsent messages, wherein one of the selections corresponds to the draft of the instant message; and
sending to the second computer system being used by the second user, each of the unsent messages, including the draft of the instant message, that corresponds to one of the selections.

14. A computer program product stored in a computer readable medium, comprising functional descriptive material that, when executed by an information handling system, causes the information handling system to perform actions that include:
establishing, over a computer network, a first instant messaging session between a first computer system used by a first user and a second computer system used by a second user;
composing, by the first user, an instant message;
detecting that the second user has logged off the instant messaging session before the first user can send the composed instant message;
saving, at the first computer system, a draft of the instant message on a nonvolatile storage device accessible from the first computer system;
establishing, over the computer network, a second instant messaging session between the first computer system used by the first user and the second computer system used by the second user;
identifying the saved draft of the instant message in response to establishing the second instant messaging;
retrieving the saved draft of the instant message from the nonvolatile storage device accessible from the first computer system; and
sending the identified saved draft of the instant messaging from the first computer system to the second computer system.

15. The computer program product of claim 14 further comprising functional descriptive material that causes the data processing system to perform additional actions that include:
after the identifying, loading the saved draft of the instant message into an editor; and
receiving one or more edits to the loaded draft, wherein the saved draft of the instant message that is sent to the second computer system includes the one or more edits.

16. The computer program product of claim 14 further comprising functional descriptive material that causes the data processing system to perform additional actions that include:
after the identifying, displaying the saved draft of the instant message to the first user; and
receiving a request from the first user, wherein the identified saved draft of the instant message is sent in response to the first user requesting to send the saved draft of the instant message.

17. The computer program product of claim 16 further comprising functional descriptive material that causes the data processing system to perform additional actions that include:
retaining the saved draft of the instant message in response to the first user requesting the retain the saved draft of the instant message.

18. The computer program product of claim 14 wherein the saving further comprises functional descriptive material that causes the data processing system to perform additional actions that include:
storing an identifier that corresponds to the second user and the draft of the instant message in a data store, wherein the data store includes a plurality of identifiers, including the second user's identifier, wherein each of the identifiers corresponds to an unsent message, including the draft of the instant message.

19. The computer program product of claim 18 wherein the identifying further comprises functional descriptive material that causes the data processing system to perform additional actions that include:
checking the data store for the second user's identifier when the second instant messaging session is established.

20. The computer program product of claim 19 further comprising functional descriptive material that causes the data processing system to perform additional actions that include:
identifying a plurality of unsent messages, including the draft of the instant message, in the data store, wherein each of the plurality of unsent messages corresponds to the second user's identifier;
receiving one or more selections from the first user, wherein each of the one or more selections corresponds to one of the plurality of unsent messages, wherein one of the selections corresponds to the draft of the instant message; and
sending to the second computer system being used by the second user, each of the unsent messages, including the draft of the instant message, that corresponds to one of the selections.
